(19) United States
(12) Patent Application Publication
(10) Pub. No.: US 2026/0104656 A1
(43) Pub. Date: Apr. 16, 2026

(54) IMAGE FORMING APPARATUS

(71) Applicants: Satoshi TAKAHASHI, Kanagawa (JP); Katsuhiko MAEDA, Kanagawa (JP); Yuugo MATSUURA, Kanagawa (JP); Yuki HONDA, Kanagawa (JP); Kohsuke HARADA, Kanagawa (JP)

(72) Inventors: Satoshi TAKAHASHI, Kanagawa (JP); Katsuhiko MAEDA, Kanagawa (JP); Yuugo MATSUURA, Kanagawa (JP); Yuki HONDA, Kanagawa (JP); Kohsuke HARADA, Kanagawa (JP)

(73) Assignee: Ricoh Company, Ltd., Tokyo (JP)

(21) Appl. No.: 19/327,672

(22) Filed: Sep. 12, 2025

(30) Foreign Application Priority Data
Oct. 16, 2024 (JP) 2024-180826

(51) Int. Cl. G03G 15/043; B41J 2/447; G03G 15/00; G03G 15/01; G03G 15/04; H04N 1/29

(52) U.S. Cl. CPC G03G 15/043; B41J 2/447; G03G 15/011; G03G 15/0189; G03G 15/04018; G03G 15/5041; H04N 1/295; H04N 2201/0094

(57) ABSTRACT

An image forming apparatus includes a first optical writer; a second optical writer adjacent to the first optical writer in the scanning direction; an image former; and multiple sensors. Each end of the first scanning region and the second scanning region is overlapped in a first overlapping region of the first image bearer at a center of the first image bearer in the scanning direction. The image former forms a first correction pattern in a first transfer region in the second image bearer corresponding to the first scanning region of the first image bearer; and a second correction pattern in a second transfer region in the second image bearer corresponding to the second scanning region of the first image bearer. The multiple sensors include a common sensor to detect both the first correction pattern and the second correction pattern in a second overlapping region on the second image bearer.

### CROSS-REFERENCE TO RELATED APPLICATIONS

This patent application is based on and claims priority pursuant to 35 U.S.C. § 119(a) to Japanese Patent Application No. 2024-180826, filed on Oct. 16, 2024, in the Japan Patent Office, the entire disclosure of which is hereby incorporated by reference herein.

### BACKGROUND

### Technical Field

The present disclosure relates to an image forming apparatus.

### Related Art

A technique has been developed for image forming apparatuses in which image bearers are irradiated with image light corresponding to image data to form latent images on the image bearers, the latent images are visualized by developing units, and the visualized images are transferred onto recording paper to form an image. In the technique, two light beam scanning devices are arranged side by side for each color in a scanning direction to irradiate an image bearer with image light corresponding to image data to form images on the image bearer, and the images are joined together on the image bearer to increase an image width, resulting in an increase in printing speed.

### SUMMARY

An image forming apparatus includes a first image bearer on which a first latent image and a second latent image are formed; a second image bearer on which the first latent image and the second latent image are transferred from the first image bearer; an optical writing device including: a first optical writer to emit and scan a first light beam in a scanning direction onto a first scanning region in the first image bearer to form the first latent image on the first scanning region; and a second optical writer adjacent to the first optical writer in the scanning direction, the second optical writer to emit and scan a second light beam in the scanning direction onto a second scanning region in the first image bearer to form the second latent image on the second scanning region, and each end of the first scanning region and the second scanning region is overlapped in a first overlapping region of the first image bearer at a center of the first image bearer in the scanning direction; an image former; and multiple sensors. The image former develops the first latent image and the second latent image with a single-color toner into a first toner image and a second toner image, respectively; and transfers the first toner image and the second toner image onto the second image bearer to respectively form: a first correction pattern in a first transfer region in the second image bearer corresponding to the first scanning region of the first image bearer; and a second correction pattern in a second transfer region in the second image bearer corresponding to the second scanning region of the first image bearer. Each end of the first transfer region and the second transfer region is overlapped in a second overlapping region of the second image bearer at a center of the second image bearer in the scanning direction. The multiple sensors detect at least one of the first correction pattern on the first transfer region or the second correction pattern on the second transfer region. The multiple sensors include a common sensor to detect both the first correction pattern and the second correction pattern in the second overlapping region on the second image bearer.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of an image forming apparatus according to a first embodiment of the present disclosure;

FIG. 2 is a diagram illustrating an example of an image formation device included in the image forming apparatus according to the first embodiment of the present disclosure;

FIG. 3 is a diagram illustrating light beam scanning devices included in the image forming apparatus according to the first embodiment of the present disclosure, when viewed from the top;

FIG. 4 is a diagram illustrating an example of an image forming control unit and a light beam scanning device included in the image forming apparatus according to the first embodiment of the present disclosure;

FIG. 5 is a diagram illustrating an example of an image data division unit included in the image forming apparatus according to the first embodiment of the present disclosure;

FIG. 6 is a diagram illustrating an example of a printer control unit of the image forming apparatus according to the first embodiment of the present disclosure;

FIG. 7 is a flowchart illustrating an example of a printing control process of the image forming apparatus according to the first embodiment of the present disclosure;

FIG. 8 is a diagram illustrating an example of an image forming correction function of the image forming apparatus according to the first embodiment of the present disclosure;

FIG. 9 is a diagram illustrating an example arrangement of pattern detection sensors in the related art;

FIG. 10 is a diagram illustrating an example arrangement of pattern detection sensors in the image forming apparatus according to the first embodiment of the present disclosure;

FIG. 11 is a flowchart illustrating an example of a pattern detection process of the image forming apparatus according to the first embodiment of the present disclosure;

FIG. 12 is a diagram illustrating an example of correction patterns in a region defined in the image forming apparatus according to the first embodiment of the present disclosure;

FIG. 13 is a diagram illustrating an example movement of pattern detection sensors in an image forming apparatus according to a second embodiment of the present disclosure; and

FIG. 14 is a flowchart illustrating an example of a pattern detection process during the movement of the pattern detection sensors in the image forming apparatus according to the second embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In a typical optical scanning device, scan lines of multiple optical scanning units are joined together to form a single line. In such an optical scanning device, in order to prevent the boundaries between scan lines of different colors that form the same line from overlapping to make the boundaries between scanning regions less noticeable, the total number of dots in one line is divided into three groups, and printing is performed by allocating the groups of dots to an image, starting from the beginning of the image. In this case, overlapping regions are provided such that the scanning regions can partially overlap on a photoconductor by several millimeters, and the pixel positions, which indicate the boundaries between the groups of dots, are not fixed and vary for different colors.

However, in an image forming apparatus including two light beam scanning devices for each color, a sensor is provided for each of the light beam scanning devices arranged side by side in the main scanning direction to detect a pattern for performing positional misalignment correction, resulting in an increase in the number of components and cost.

According to one embodiment of the present disclosure, in an image forming apparatus including two light beam scanning devices arranged side by side for each color in a scanning direction, no additional sensors are provided, resulting in a reduction in cost.

An image forming apparatus according to embodiments of the present disclosure will be described in detail hereinafter with reference to the accompanying drawings.

### First Embodiment

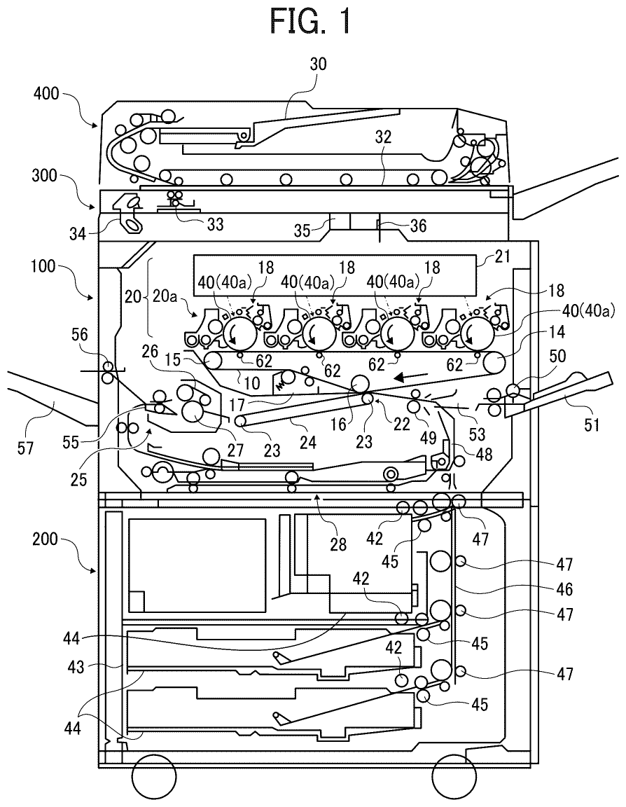

FIG. 1 is a diagram illustrating an example of an image forming apparatus according to a first embodiment of the present disclosure. A printer 100 is an image forming apparatus according to the present embodiment. The printer 100 includes an intermediate transfer unit at the center thereof, and the intermediate transfer unit includes an intermediate transfer belt 10, which is an endless belt. The intermediate transfer belt 10 is wound around three support rollers, namely, a first support roller 14, a second support roller 15, and a third support roller 16, and is driven to rotate clockwise. An intermediate transfer member cleaning unit 17 is provided to the right of the second support roller 15 in FIG. 1 to remove residual toner remaining on the intermediate transfer belt 10 after an image is transferred. An image formation device 20 is located on the intermediate transfer belt 10 between the first support roller 14 and the second support roller 15 along the movement direction of the intermediate transfer belt 10, and includes photoconductor units 40, charging units 18, developing units 13, and cleaning units 12 for yellow (Y), magenta (M), cyan (C), and black (K) colors. The image formation device 20 is removably mounted on the main body of the printer 100.

A light beam scanning device 21 is disposed above the image formation device 20 to irradiate photoconductor drums 40a of the photoconductor units 40 of the colors described above with laser beams to form images. A secondary transfer unit 22 is disposed below the intermediate transfer belt 10. The secondary transfer unit 22 includes a secondary transfer belt 24, which is an endless belt, around two rollers 23, and is arranged so as to push up the intermediate transfer belt 10 to press the intermediate transfer belt 10 against the third support roller 16. The secondary transfer belt 24 transfers the image on the intermediate transfer belt 10 onto a fed sheet. A fixing unit 25 is located next to the secondary transfer unit 22 to fix the image transferred on the sheet. A sheet onto which a toner image has been transferred is fed to the fixing unit 25.

The fixing unit 25 includes a fixing belt 26, which is an endless belt, and a heat and pressure roller 27 to melt and press the toner image transferred onto the sheet to fix the toner image to the sheet. A sheet reversing unit 28 is located below the secondary transfer unit 22 and the fixing unit 25 to turn the sheet over after an image has just been formed on the front side of the sheet, in order to also record an image on the back side of the sheet.

In response to the pressing of a start switch of an operation unit of the image forming apparatus, a document placed on a document tray 30 of an automatic document feeder (ADF) 400 is fed onto a contact glass 32. When no document is placed on the ADF 400, a scanner of an image reading unit 300 is driven to read and scan a first carriage 33 and a second carriage 34 to read a document manually placed on the contact glass 32. Then, light is emitted from a light source on the first carriage 33 to the contact glass 32, and reflected light from the surface of the document is reflected by a mirror on the first carriage 33 toward the second carriage 34. The light is then reflected by a mirror on the second carriage 34, passes through an imaging forming lens 35, and forms an image on a reading sensor 36, such as a charge-coupled device (CCD) reading sensor. Recording data for each of the Y, M, C, and K colors is generated based on an image signal obtained by the reading sensor 36.

In response to the pressing of the start switch or in response to receipt of an image output instruction from a personal computer (PC) or the like or receipt of a facsimile output instruction, the intermediate transfer belt 10 starts to be driven to rotate, and each unit of the image formation device 20, which includes starts to prepare for image formation. Then, an image formation sequence for forming images of the respective colors is started, and exposure laser beams, which are modulated based on recording data for the respective colors, are projected onto the photoconductor drums 40a of the respective colors. Through the image formation processes for the respective colors, toner images of the respective colors are transferred onto the intermediate transfer belt 10 in a superimposed manner to form a single toner image on the intermediate transfer belt 10. The toner image on the intermediate transfer belt 10 is transferred onto a sheet that is fed to the secondary transfer unit 22 at a timing when the leading edge of the sheet in the secondary transfer unit 22 coincides with the leading edge of the toner image in the secondary transfer unit 22. That is, the secondary transfer unit 22 is an example of a transfer unit that transfers images visualized by the developing units 13 onto the secondary transfer belt 24 (an example of a belt). The sheet onto which the toner image has been transferred is fed to the fixing unit 25, and the fixing unit 25 fixes the toner image to the sheet.

The sheet is fed from one of multiple sheet feed trays 44 of a sheet feed unit 43. Specifically, one of sheet feed rollers 42 of a sheet feed table 200 is selectively rotated to feed sheets from a corresponding one of the multiple sheet feed trays 44, and the sheets are separated one by one by a separation roller 45. The separated sheet is then guided to a conveyance roller unit 46 and fed by a conveyance roller 47 to a conveyance roller unit 48 in the printer 100. Then, the sheet is stopped at a registration roller 49 of the conveyance roller unit 48, and then fed to the secondary transfer unit 22 at the timing described above. A sheet on a manual feed tray 51 may be fed. In a case where a user places sheets on the manual feed tray 51, the printer 100 rotationally drives a feed roller 50 to separate one of the sheets on the manual feed tray 51, guide the sheet into a manual feed path 53, and stop the sheet at the registration roller 49 in a similar manner.

The sheet to be discharged after having been subjected to a fixing process by the fixing unit 25 is guided to a discharge roller 56 by a switching claw 55 and stacked on an output tray 57. Alternatively, the sheet is guided to the sheet reversing unit 28 by the switching claw 55, and is reversed and guided to the transfer position again to record an image on the back side of the sheet. Then, the sheet is discharged onto the output tray 57 by the discharge roller 56. Residual toner remaining on the intermediate transfer belt 10 after the secondary transfer process is removed by the intermediate transfer member cleaning unit 17 to prepare the intermediate transfer belt 10 for the next image formation.

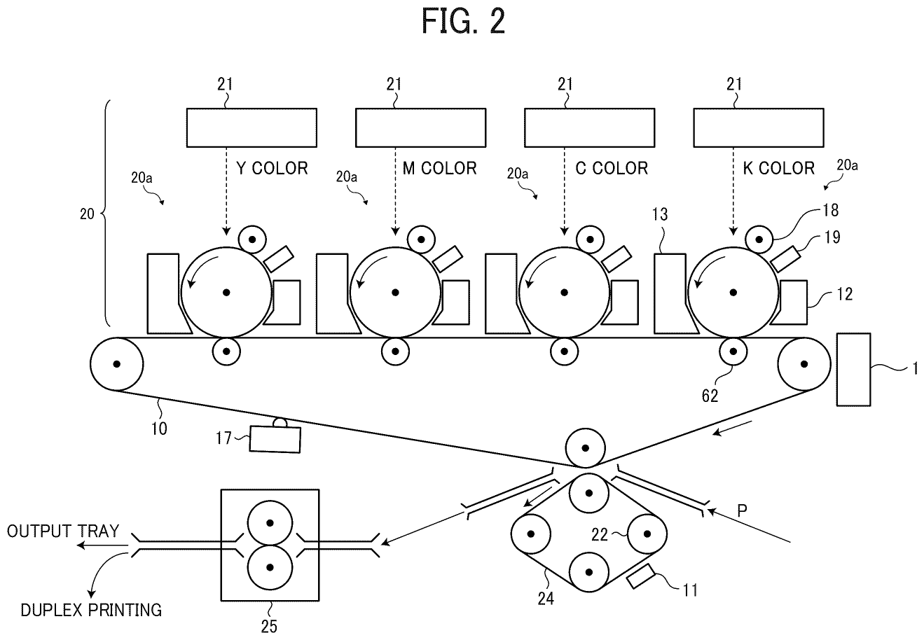

FIG. 2 is a diagram illustrating an example of the image formation device 20 included in the image forming apparatus according to the first embodiment of the present disclosure. In the present embodiment, the image formation device 20 includes four image formation units 20a and four light beam scanning devices 21 to form a color image by superimposing images of four colors (yellow, magenta, cyan, and black) on one another.

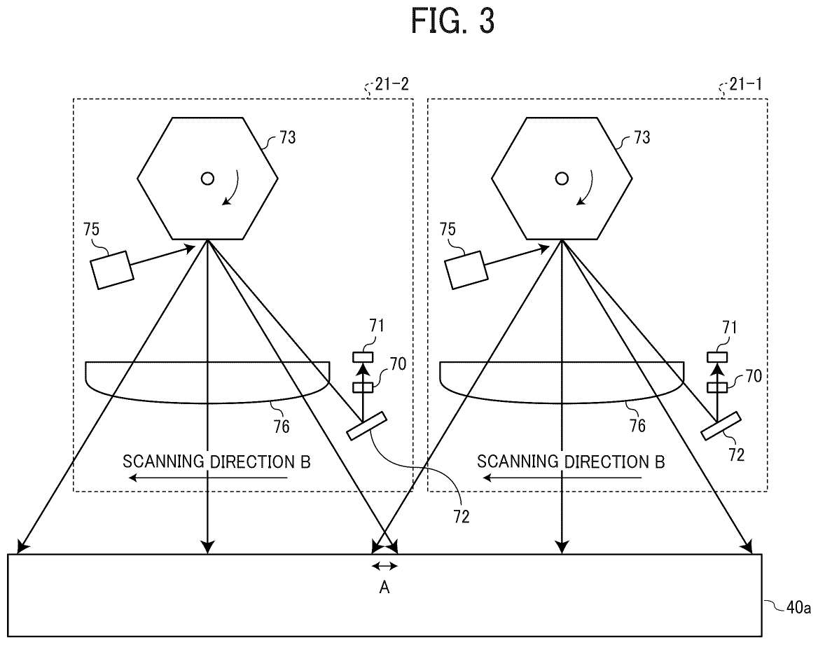

As will be described with reference to FIG. 3, each of the light beam scanning devices 21 (an example of an optical writing device) includes a laser diode (LD) unit 75 that is driven and modulated in accordance with image data to selectively emit a light beam, and the emitted light beam is deflected by a polygon mirror 73 rotated by a polygon motor, passes through an fθ lens 76, is reflected by a folding mirror 77, and scans a corresponding one of the photoconductor drums 40a. Each of the light beam scanning devices 21 includes multiple light beam scanning devices, namely, light beam scanning devices 21-1 and 21-2 (see FIG. 3), arranged side by side in a main scanning direction B (an example of a scanning direction). Each of the light beam scanning devices 21-1 and 21-2 is an example of an optical writing unit or optical writer that scans a photoconductor drum 40a (an example of an image bearer) with a light beam corresponding to image data using a single LD unit 75 to form a latent image. A scanning region on the photoconductor drum 40a is divided into multiple sub-regions in the main scanning direction B, and each of the multiple sub-regions (or divided regions) is irradiated with a light beam by a corresponding one of the light beam scanning devices 21-1 and 21-2. As a result, each of the light beam scanning devices 21 forms a latent image.

For each color, a charger (i.e., the charging unit 18), the developing unit 13 (an example of a toner developing unit) for visualizing a latent image, a transfer device 62, the cleaning unit 12, and a static eliminator 19 are provided around the photoconductor drum 40a. Through a typical electrophotographic process including charging, exposure, development, and transfer, an image of the first color is formed on the intermediate transfer belt 10. Then, images of the second, third, and fourth colors are transferred onto the intermediate transfer belt 10 in this order to superimpose images of the four colors on one another to form a color image. Further, the image formed on the intermediate transfer belt 10 is transferred onto fed recording paper P (or sheet) by the secondary transfer unit 22. As a result, the color image obtained by superimposing the images of the four colors on one another is formed on the recording paper P. Then, the image on the recording paper P is fixed by the fixing unit 25. The intermediate transfer member cleaning unit 17 is provided to remove the toner images on the intermediate transfer belt 10. That is, the four image formation units 20a are an example of an image former that develops latent images on the multiple photoconductor drums 40a with toners of different colors to form images of the respective colors and transfer the images to the intermediate transfer belt 10 (an example of a second image bearer) in a superimposed manner to form an image.

A secondary transfer belt cleaning unit 11 is provided to remove the toner images on the secondary transfer belt 24. Further, for each color, a toner bottle containing toner to be supplied to a corresponding one of the developing units 13 is provided.

The intermediate transfer belt 10 is provided with multiple pattern detection sensors 1 (also referred to as detection sensors) to detect patterns (for example, a test pattern image for positional misalignment correction and a test pattern image for density correction) for correcting image forming conditions for forming a color image on the intermediate transfer belt 10. The image forming apparatus calculates various misalignment amounts including a skew (or inclination) of each color with respect to a reference color, an amount of main-scanning registration misalignment, an amount of sub-scanning registration misalignment, and a main-scanning magnification error, based on the detection results of the pattern detection sensors 1, corrects various misalignment amounts related to image quality adjustment, based on the calculation results, corrects image forming conditions (e.g., positional misalignment correction and density correction) for forming a color image on the intermediate transfer belt 10, and executes various processes related to the generation of test pattern images for image adjustment.

FIG. 3 is a diagram illustrating one of the light beam scanning devices 21 included in the image forming apparatus according to the first embodiment of the present disclosure, when viewed from the top. The light beam scanning devices 21 have the same configuration irrespective of the color. The light beam scanning device 21 of each color includes two light beam scanning devices 21-1 and 21-2 arranged side by side in the scanning direction B. The light beam scanning devices 21-1 and 21-2 have the same configuration. Specifically, a light beam emitted from an LD unit 75 passes through a cylinder lens (CYL) and is incident on a polygon mirror 73. The polygon mirror 73 rotates to deflect the light beam, and the deflected light beam passes through an fθ lens 76 and scans the corresponding photoconductor drum 40a with a folding mirror 77. In the present embodiment, as a non-limiting example, the two light beam scanning devices 21-1 and 21-2 scan the same photoconductor drum 40a in the same scanning direction. In another example, the two light beam scanning devices 21-1 and 21-2 may scan the same photoconductor drum 40a in different directions from the center toward the ends of the photoconductor drum 40a in the scanning direction B.

Each of the light beam scanning devices 21-1 and 21-2 includes a synchronization mirror 72, a synchronization lens, and a synchronization sensor 71 in a writing-side end portion thereof in the main scanning direction B, and is configured such that the light beam transmitted through the fθ lens 76 is reflected by the synchronization mirror 72, condensed by the synchronization lens 70, and incident on the synchronization sensor 71. The synchronization sensor 71 serves to detect a synchronization detection signal for determining the start timing of writing for main scanning.

In the present embodiment, the image forming apparatus divides image data into multiple (for example, two) segments, transmits each of the multiple segments (divided image data) to a corresponding one of the light beam scanning devices 21-1 and 21-2, and scans (or irradiates) the photoconductor drum 40a with light beams such that latent images formed by the light beam scanning devices 21-1 and 21-2 are joined together on the photoconductor drum 40a.

In the present embodiment, furthermore, in the image forming apparatus, a region A is defined near the center of the photoconductor drum 40a such that the region A can be scanned by both the light beam scanning devices 21-1 and 21-2. The region A may be referred to as a “beam overlapping region” or simply as an “overlapping region”. That is, in the present embodiment, in the image forming apparatus, a boundary portion between the two divided regions defines the beam overlapping region (an example of a region) A, which can be irradiated with light beams by the two adjacent light beam scanning devices 21-1 and 21-2. In other words, based on a portion of divided image data, light beams can be emitted from both the two adjacent light beam scanning devices 21-1 and 21-2.

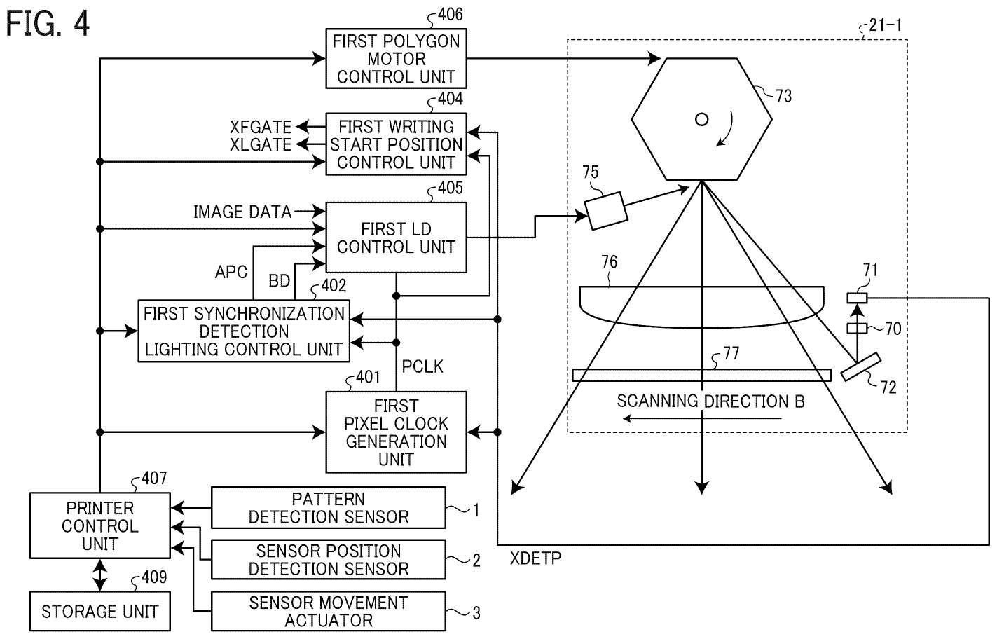

FIG. 4 is a diagram illustrating an example of an image forming control unit and the light beam scanning device 21-1, which are included in the image forming apparatus according to the first embodiment of the present disclosure. While FIG. 4 illustrates a control unit for the light beam scanning device 21-1, the same applies to the light beam scanning device 21-2, except for a printer control unit 407, a storage unit 409 (correction data storage unit), a pattern detection sensor 1, a sensor position detection sensor 2, and a sensor movement actuator 3. The light beam scanning devices 21 of the respective colors have similar configurations.

The light beam scanning device 21-1 includes a synchronization sensor 71 on an image writing side at an end thereof in the main scanning direction B to detect a light beam, and is configured such that the light beam transmitted through the fθ lens 76 is reflected by the synchronization mirror 72, condensed by the synchronization lens, and incident on the synchronization sensor 71. In response to the light beam passing over the synchronization sensor 71, the synchronization sensor 71 outputs a synchronization detection signal XDETP to a first pixel clock generation unit 401, a first synchronization detection lighting control unit 402, and a first writing start position control unit 404. The first pixel clock generation unit 401 generates a pixel clock PCLK synchronized with the synchronization detection signal XDETP and transmits the pixel clock PCLK to the first writing start position control unit 404, the first synchronization detection lighting control unit 402, and a first LD control unit 405.

The first synchronization detection lighting control unit 402 turns on a forced LD lighting signal BD to forcibly turn on the LD unit 75 (hereinafter also referred to as “LD”) in order to initially detect the synchronization detection signal XDETP. After the detection of the synchronization detection signal XDETP, the first synchronization detection lighting control unit 402 uses the synchronization detection signal XDETP and the pixel clock PCLK to generate the forced LD lighting signal BD for turning on the LDs at a timing when the synchronization detection signal XDETP can be reliably detected without causing flare light and turning off the LD in response to the detection of the synchronization detection signal XDETP, and transmits the forced LD lighting signal BD to the first LD control unit 405. The first synchronization detection lighting control unit 402 further generates an optical power control timing signal APC for each LD using the synchronization detection signal XDETP and the pixel clock PCLK, and transmits the optical power control timing signal APC to the first LD control unit 405. The optical power control timing signal APC is executed outside an image writing area. At the timing indicated by the optical power control timing signal APC, the optical power is controlled to a target optical power.

The first LD control unit 405 controls the LD to turn on in accordance with the forced LD lighting signal BD, the optical power control timing signal APC, and image data synchronized with the pixel clock PCLK. Then, a laser beam is emitted from the LD, is deflected by the polygon mirror 73, passes through the fθ lens 76, and scans the photoconductor drum 40a with the folding mirror 77.

A first polygon motor control unit 406 controls the polygon motor to rotate at a predetermined rotational speed in accordance with a control signal from the printer control unit 407. The first writing start position control unit 404 uses, for example, the synchronization detection signal XDETP, the pixel clock PCLK, and a control signal from the printer control unit 407 to generate a main-scanning control signal XLGATE and a sub-scanning control signal XFGATE for determining an image writing start timing and an image width.

In an image forming operation, correction data stored in the storage unit 409 is read in accordance with an instruction from the printer control unit 407, and is set in the first writing start position control unit 404 and the first pixel clock generation unit 401.

The pattern detection sensor 1 that detects a correction pattern transmits image pattern information of the detected correction pattern to the printer control unit 407. The printer control unit 407 calculates various misalignment amounts including a skew (or inclination) of each color with respect to a reference color, an amount of main-scanning registration misalignment, an amount of sub-scanning registration misalignment, and a main-scanning magnification error, corrects the various misalignment amounts related to image quality adjustment, based on the calculation results, and stores correction data in the storage unit 409. The sensor movement actuator 3 moves the pattern detection sensor 1 in the scanning direction B, and the sensor position detection sensor 2 detects the position of the pattern detection sensor 1.

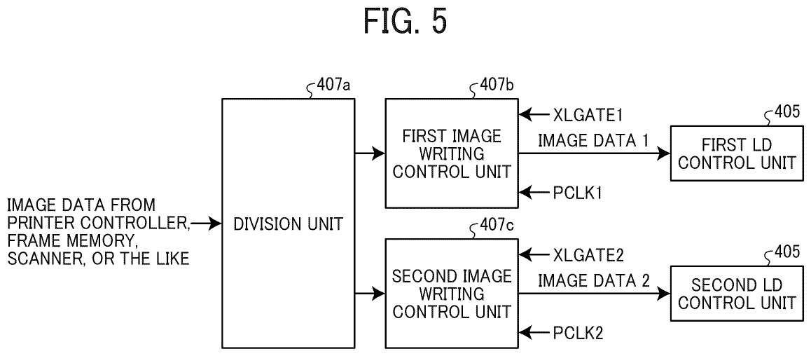

FIG. 5 is a diagram illustrating an example of an image data division unit included in the image forming apparatus according to the first embodiment of the present disclosure. As illustrated in FIG. 5, the printer control unit 407 of the image forming apparatus according to the present embodiment includes a division unit 407a, a first image writing control unit 407b, and a second image writing control unit 407c. The division unit 407a receives image data from, for example, a printer controller, a frame memory, or a scanner. The division unit 407a divides the received image data into two segments for each line, and transmits one of the segments to the first image writing control unit 407b and the other segment to the second image writing control unit 407c. That is, the division unit 407a is an example of a division unit that divides image data into segments each for a corresponding one of the light beam scanning devices 21-1 and 21-2. The division unit 407a, the first image writing control unit 407b, and the second image writing control unit 407c have a function of a line memory.

For example, the number of image data items in a portion near the boundary between a region (divided region) to be irradiated with a light beam by the light beam scanning device 21-1 and a region (divided region) to be irradiated with a light beam by the light beam scanning device 21-2 in the main scanning direction B is set to 100, and the number of image data items in one line is set to 2000, which is represented by image data items D1 to D2000. In this case, the division unit 407a divides the input image data items D1 to D2000 in one line into segments each for a corresponding one of the light beam scanning devices 21-1 and 21-2. That is, the division unit 407a functions as an example of a division unit that divides image data into segments each for a corresponding one of the light beam scanning devices 21-1 and 21-2. Then, the division unit 407a transmits the image data items D1 to D1050 to the first image writing control unit 407b, and the image data items D950 to D2000 to the second image writing control unit 407c.

Accordingly, the image data items D950 to D1050, which corresponds to the portion near the boundary between the regions irradiated with the light beams by the light beam scanning devices 21-1 and 21-2, are transmitted to both the first image writing control unit 407b and the second image writing control unit 407c. That is, the division unit 407a secures at least one of the amounts of data included for both the two adjacent light beam scanning devices 21-1 and 21-2 within the image data after division (i.e., the divided image data), such that the amount of data is equal to or greater than the image position adjustment amount in the main scanning direction B. At this time, the first image writing control unit 407b and the second image writing control unit 407c may store the divided image data in a memory and adjust the image data to be read from the memory. Alternatively, the image forming apparatus secures the beam overlapping region A where both the adjacent light beam scanning devices 21-1 and 21-2 can irradiate the photoconductor drum 40a with light beams, such that the beam overlapping region A has a width equal to or greater than the image position adjustment amount in the main scanning direction B.

That is, at least one of the beam overlapping region A where both the two adjacent light beam scanning devices 21-1 and 21-2 can irradiate the boundary between the multiple divided regions with light beams and the amount of data included for both the two adjacent light beam scanning devices 21-1 and 21-2 within the divided image data is secured in an amount equal to or greater than the image position adjustment amount in the main scanning direction B.

The first image writing control unit 407b and the second image writing control unit 407c transmit divided image data captured from, for example, the printer controller, the frame memory, or the scanner to the first LD control unit 405 and a second LD control unit 405, respectively, in synchronization with the pixel clock PCLK 1 and PCLK 2 at the timings indicated by the sub-scanning control signal XFGATE and the main-scanning control signals XLGATE 1 and XLGATE 2. At the time of transmission of the divided image data to the first and second LD control units 405, the respective LDs are turned on and irradiate the photoconductor drum 40a with light beams to write the divided image data on the photoconductor drum 40a. As described above, the time at which the image data is read from the line memory and the addresses to which the image data is to be transmitted are determined. Thus, the desired image data can be transmitted to the first and second LD control units 405 at an appropriate time.

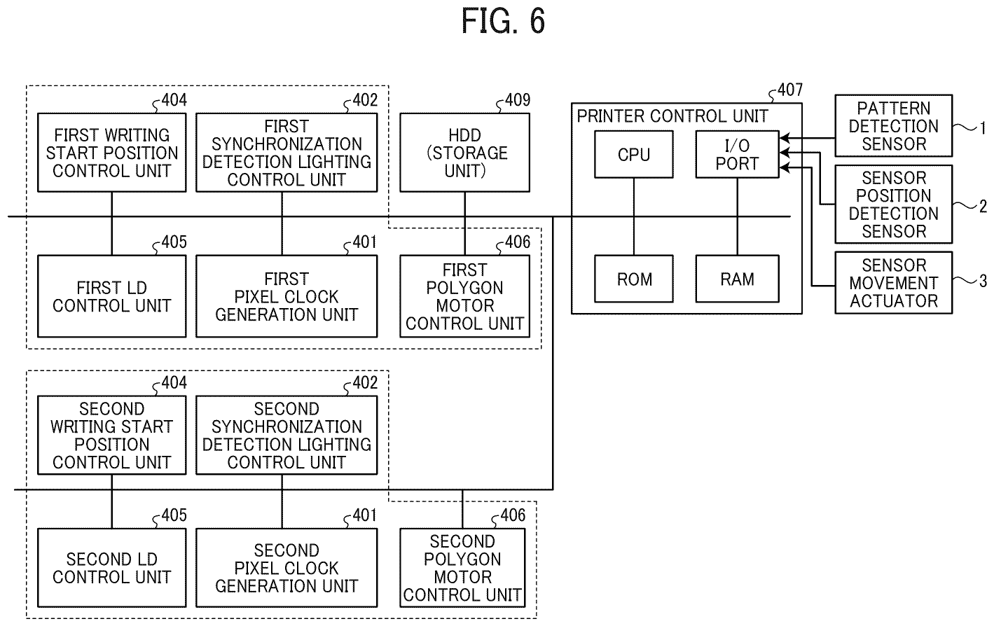

FIG. 6 is a diagram illustrating an example of the printer control unit 407 of the image forming apparatus according to the first embodiment of the present disclosure. The printer control unit 407 includes a central processing unit (CPU), a random access memory (RAM), a read-only memory (ROM), and an input/output (I/O) port, and the hardware elements of the printer control unit 407 are coupled to each other via a bus. The CPU is a device that executes a program for controlling the operation of the image forming apparatus and performs predetermined processing. The RAM is a volatile memory for providing an area for programs to be executed by the CPU, and is used for storing and expanding programs and data. The ROM is a non-volatile memory for storing, for example, programs and firmware to be executed by the CPU. The I/O port is a device that processes, for example, information to be output to a motor controlled by the CPU and information input from various sensors.

The I/O port is coupled to the pattern detection sensor 1 that detects an image pattern, the sensor movement actuator 3 that moves the pattern detection sensor 1, and the sensor position detection sensor 2 that detects the position of the moved pattern detection sensor 1.

The first writing start position control unit 404, a second writing start position control unit 404, the first and second LD control units 405, the first synchronization detection lighting control unit 402, a second synchronization detection lighting control unit 402, the first pixel clock generation unit 401, a second pixel clock generation unit 401, the first polygon motor control unit 406, a second polygon motor control unit 406, and a hard disk drive (HDD) (i.e., the storage unit 409) are also coupled to each other via the bus, and, for example, the setting of various data, ON/OFF control, and storage and reading of data are performed in accordance with instructions from the CPU.

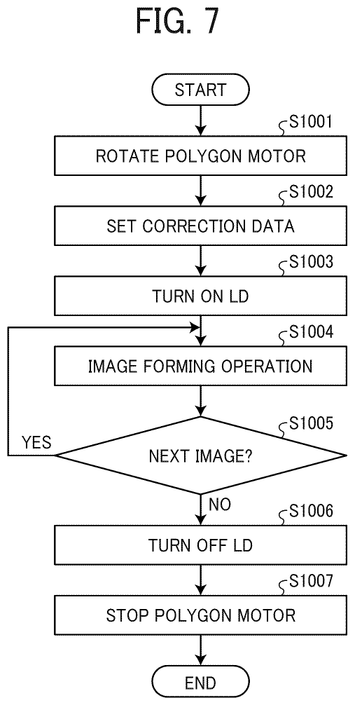

FIG. 7 is a flowchart illustrating an example of a printing control process of the image forming apparatus according to the first embodiment of the present disclosure. In response to the pressing of a start key on an operation panel, first, the printer control unit 407 rotates the polygon motor at a predetermined rotational speed (step S1001). Then, the printer control unit 407 sets correction data (e.g., set values of writing start positions in the main scanning direction B and the sub-scanning direction and a magnification) in each control unit (step S1002), turns on each LD to output a synchronization detection signal, and performs an automatic power control (APC) operation to enable each LD to be lit with a predetermined optical power (step S1003). Thereafter, the printer control unit 407 starts an image forming operation (step S1004). If there is no next image (step S1005: No), the printer control unit 407 turns off each LD (step S1006) and stops the polygon motor (step S1007). Then, the process ends. If there is a next image (step S 1005: Yes), the process returns to step S1004.

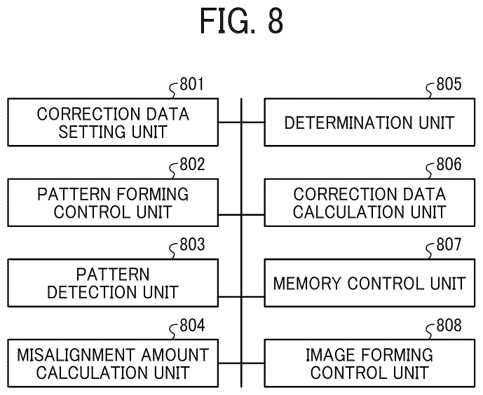

FIG. 8 is a diagram illustrating an example of an image forming correction function of the image forming apparatus according to the first embodiment of the present disclosure. Specifically, FIG. 8 is a functional block diagram of functions implemented by the printer control unit 407 executing an image formation correction program stored in the ROM.

As illustrated in FIG. 8, the printer control unit 407 executes the image formation correction program to implement functions such as a correction data setting unit 801, a pattern forming control unit 802, a pattern detection unit 803, a misalignment amount calculation unit 804, a determination unit 805, a correction data calculation unit 806, a memory control unit 807, and an image forming control unit 808.

The correction data setting unit 801 sets the correction data stored in the storage unit 409 in the first and second pixel clock generation units 401. The pattern forming control unit 802 generates correction patterns of the respective colors on the intermediate transfer belt 10. The pattern detection unit 803 detects the correction patterns formed on the intermediate transfer belt 10, based on sensor outputs. That is, the pattern detection unit 803 detects the correction patterns by using the multiple pattern detection sensors 1. The misalignment amount calculation unit 804 calculates a misalignment amount based on the correction patterns detected by the pattern detection unit 803. The determination unit 805 determines whether to perform correction, based on the calculated misalignment amount. The correction data calculation unit 806 calculates correction data in a case where correction is to be performed. That is, the pattern forming control unit 802, the pattern detection unit 803, the misalignment amount calculation unit 804, the determination unit 805, and the correction data calculation unit 806 function as an example of a correction device that corrects a positional misalignment (e.g., various misalignment amounts including a skew (or inclination) of each color with respect to a reference color, an amount of main-scanning registration misalignment, an amount of sub-scanning registration misalignment, and a main-scanning magnification error) for each of the light beam scanning devices 21-1 and 21-2. The memory control unit 807 performs a process for updating the correction data stored in the storage unit 409 with the calculated correction data. The image forming control unit 808 performs a printing process based on the calculated correction data. A known correction method according to a comparative example is used to perform correction.

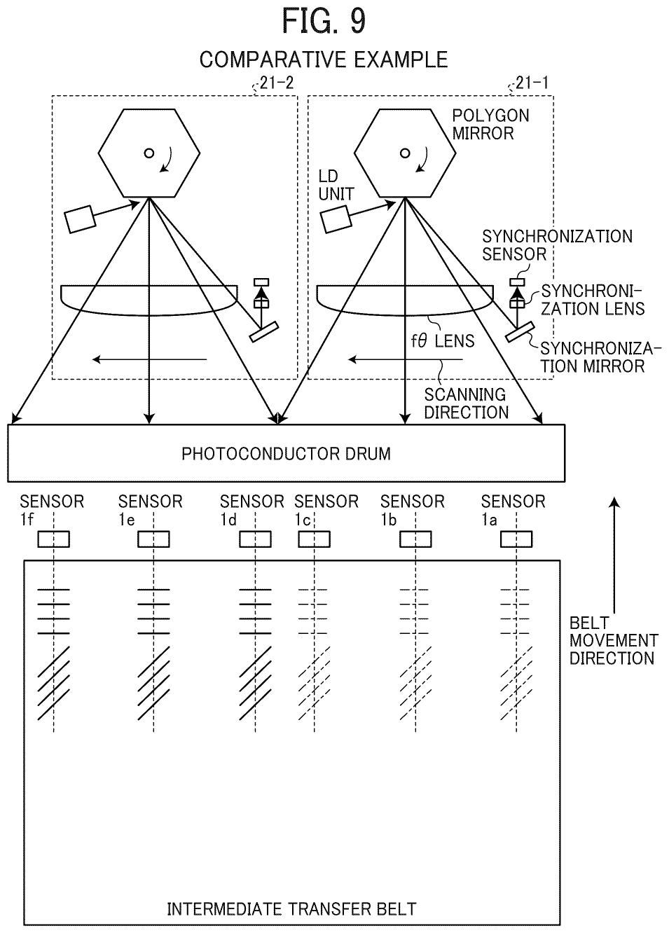

FIG. 9 is a diagram illustrating an example arrangement of pattern detection sensors in the related art. In the related art, pattern detection sensors are provided at a leading end, a trailing end, and near the center of each light beam scanning device in a light beam scanning direction. Accordingly, in the light beam scanning device 21 in which two light beam scanning devices, namely, the light beam scanning devices 21-1 and 21-2, are arranged side by side in the scanning direction B in such a manner as in the related art, as illustrated in FIG. 9, a pattern detection sensor 1a, a pattern detection sensor 1c, and a pattern detection sensor 1b are provided at the leading end, the trailing end, and the center of the light beam scanning device 21-1, respectively, and a pattern detection sensor 1d, a pattern detection sensor 1f, and a pattern detection sensor 1e are provided at the leading end, the trailing end, and the center of the light beam scanning device 21-2, respectively.

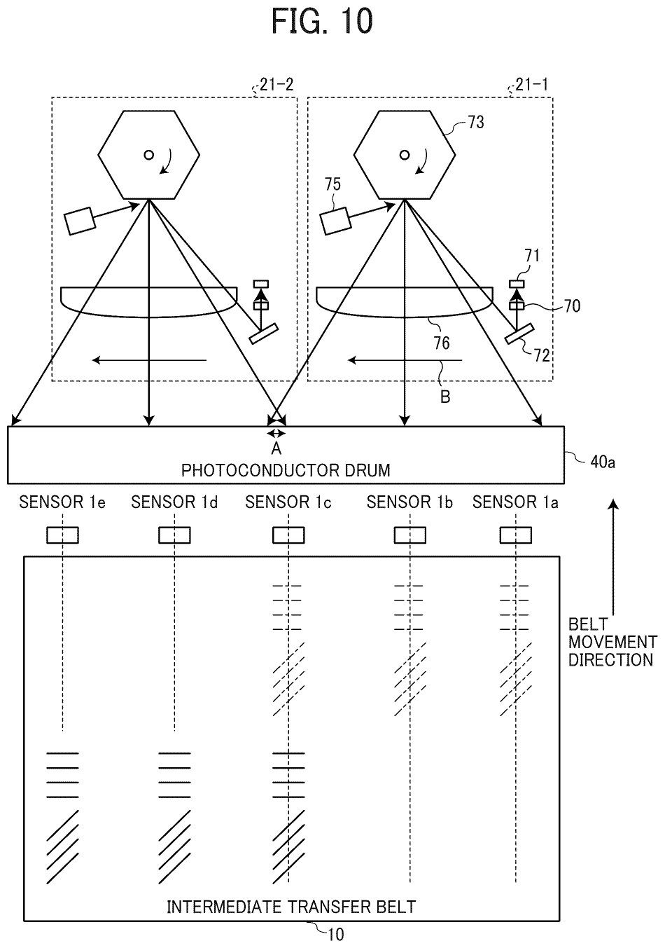

FIG. 10 is a diagram illustrating an example arrangement of pattern detection sensors in the image forming apparatus according to the first embodiment of the present disclosure. In the present embodiment, as illustrated in FIG. 3, the photoconductor drum 40a scanned with light beams by the two adjacent light beam scanning devices 21-1 and 21-2 defines, near the center thereof, a region A that can be scanned (or irradiated) with the light beams by both the light beam scanning devices 21-1 and 21-2. The region A is defined such that the regions scanned by the two adjacent light beam scanning devices 21-1 and 21-2 overlap by a certain distance at one end of each of the light beam scanning devices 21-1 and 21-2. In the region A, correction patterns are generated using the light beam scanning devices 21-1 and 21-2. The region A is provided with the pattern detection sensor 1c, and the pattern detection sensor 1c is configured to detect a correction pattern at the trailing end of the light beam scanning device 21-1 and a correction pattern at the leading end of the light beam scanning device 21-2. That is, in the region A, the correction patterns at the light beam scanning devices 21-1 and 21-2 are detected by the common pattern detection sensor 1c.

As described above, the pattern detection sensor 1c provided in the region A that can be scanned by both the light beam scanning devices 21-1 and 21-2 is used in common. This configuration eliminates an additional sensor, resulting in a reduction in cost. The pattern detection sensors 1 other than the pattern detection sensor 1c provided in the region A include the pattern detection sensors 1a and 1b at the leading end and the center of the light beam scanning device 21-1, respectively, and the pattern detection sensors 1e and 1d at the trailing end and the center of the light beam scanning device 21-2, respectively.

In the present embodiment, furthermore, since the pattern detection sensor 1c, which is provided in the region A that can be scanned by both the light beam scanning devices 21-1 and 21-2, is used in common, patterns are generated and detected at different times such that, as illustrated in FIG. 10, the correction pattern generated using the light beam scanning device 21-1 is detected and then the correction pattern generated using the light beam scanning device 21-2 is detected. That is, correction patterns are generated at different times for the two adjacent light beam scanning devices 21-1 and 21-2 and are detected by the pattern detection sensors 1a to 1e. Accordingly, correction patterns are separately detected at different times such that correction patterns are detected for the light beam scanning device 21-1 and then correction patterns are detected for the light beam scanning device 21-2. With this configuration, the pattern detection sensor 1c, which is provided in the region A that can be scanned by both the light beam scanning devices 21-1 and 21-2, can be used in common, resulting in a reduction in the number of components.

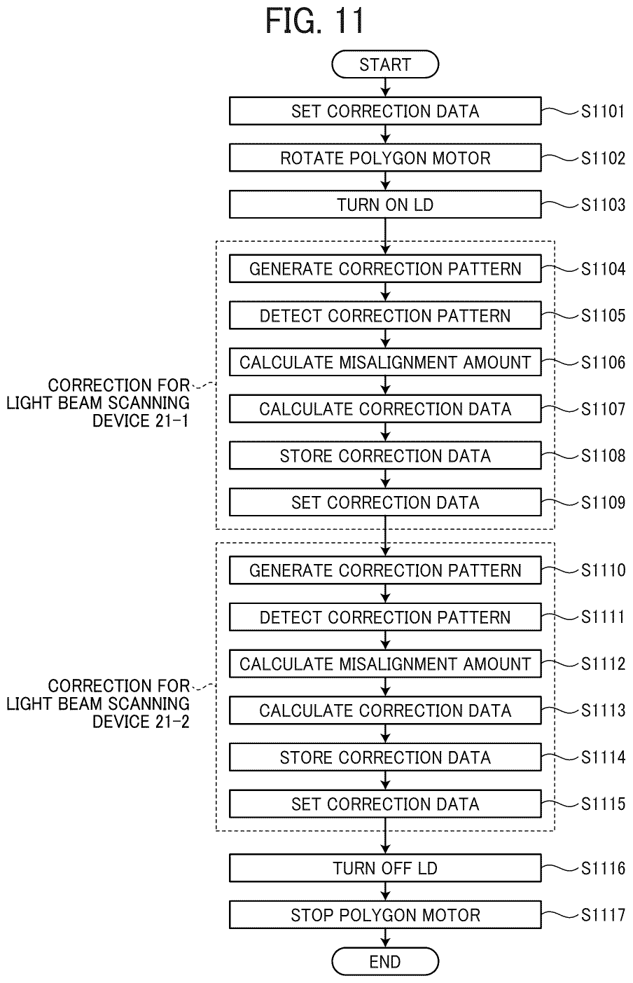

FIG. 11 is a flowchart illustrating an example of a pattern detection process of the image forming apparatus according to the first embodiment of the present disclosure. The printer control unit 407 controls the execution timings of the correction such that the correction is executed when the power of the image forming apparatus is turned on, when printing starts, every time a predetermined number of sheets are printed, or when the temperature changes by a predetermined amount or more as a result of temperature monitoring.

First, as a process for both the light beam scanning devices 21-1 and 21-2, the printer control unit 407 sets correction data stored in the storage unit 409 (step S1101). The correction data to be set here is correction data that is set in the previous correction operation and stored in the storage unit 409. Then, the printer control unit 407 rotates the polygon motor (step S1102) and turns on the LDs (step S1103).

Then, as a process for the light beam scanning device 21-1, the printer control unit 407 generates a correction pattern based on the light beam scanning device 21-1 (step S1104), detects the correction pattern using the pattern detection sensor 1 (step S1105), and calculates a misalignment amount (step S1106). Then, the printer control unit 407 calculates correction data (step S1107), causes the memory control unit 807 to store the correction data (step S1108), and sets the correction data (step S1109).

Then, as a process for the light beam scanning device 21-2, the printer control unit 407 generates a correction pattern based on the light beam scanning device 21-2 (step S1110), detects the correction pattern using the pattern detection sensor 1 (step S1111), and calculates a misalignment amount (step S1112). Then, the printer control unit 407 calculates correction data (step S1113), causes the memory control unit 807 to store the correction data (step S1114), and sets the correction data (step S1115).

Then, the printer control unit 407 turns off the LDs of both the light beam scanning devices 21-1 and 21-2 (step S1116) and stops the polygon motors (step S1117). Then, the process ends. The image forming apparatus may perform the control described above during printing. In this case, the image forming apparatus performs the processing from the generation of a correction pattern for the light beam scanning device 21-1 to the setting of correction data for the light beam scanning device 21-2 between the printing of one image and the next image. In the present embodiment, in the image forming apparatus, correction data is set for the light beam scanning device 21-1 and the light beam scanning device 21-2 in this order. However, correction data may be set for the light beam scanning device 21-2 and the light beam scanning device 21-1 in this order as long as correction data is set at different times.

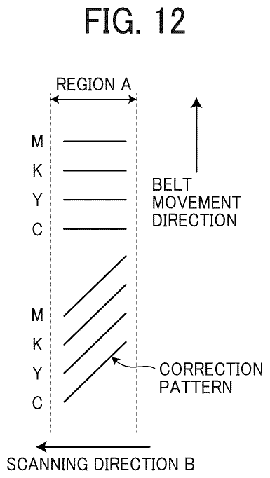

FIG. 12 is a diagram illustrating an example of correction patterns in the region A defined in the image forming apparatus according to the first embodiment of the present disclosure. As illustrated in FIG. 12, correction patterns to be generated in the region A that can be scanned by the two adjacent light beam scanning devices 21-1 and 21-2 have a width smaller than the width of the region A in the scanning direction, enabling the generation and detection of correction patterns in the region A. That is, the width of the region A in the scanning direction is larger than the width of the correction patterns in the scanning direction.

As described above, in the image forming apparatus according to the first embodiment of the present disclosure, the region A that can be written with image data by both the two light beam scanning devices 21-1 and 21-2 is defined, correction patterns are generated in the region A, based on the light beam scanning devices 21-1 and 21-2, and the correction patterns are detected by the common pattern detection sensor 1. This configuration can eliminate an additional sensor, resulting in a reduction in the cost of the image forming apparatus in which the two light beam scanning devices 21-1 and 21-2 are arranged side by side for each color in the scanning direction.

### Second Embodiment

A second embodiment describes an example in which pattern detection sensors used to detect correction patterns are movable and the detection positions of the pattern detection sensors can be switched depending on the light beam scanning device for which the correction patterns to be detected are defined. In the following, descriptions of components similar to those in the first embodiment of the present disclosure will be omitted.

In the present embodiment, the pattern detection sensors 1a to 1c are movable, and the detection positions thereof can be switched depending on the light beam scanning device 21-1 or 21-2 for which the correction patterns to be detected are defined. With this configuration, the pattern detection sensors 1a to 1c for the light beam scanning device 21-1 are used to detect correction patterns for both the two light beam scanning devices 21-1 and 21-2, resulting in a reduction in the number of components.

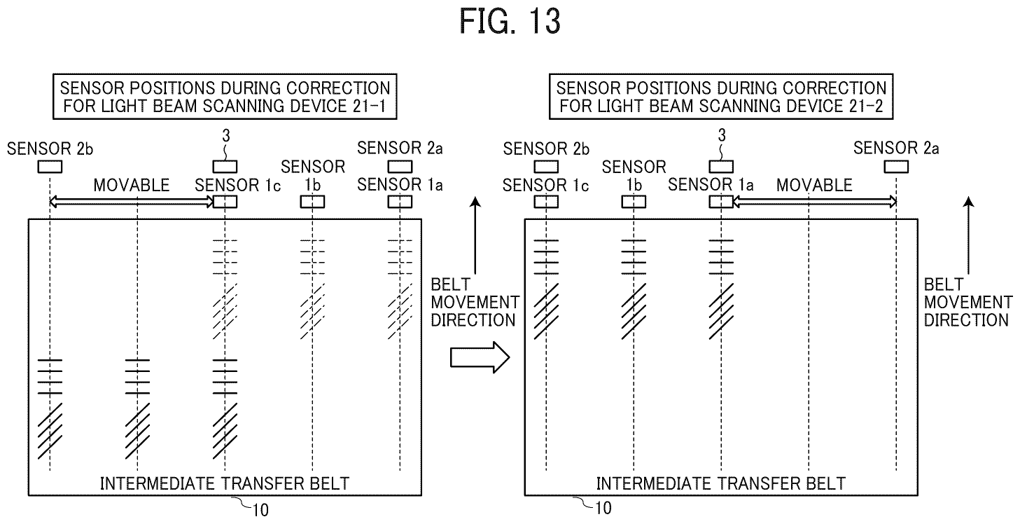

FIG. 13 is a diagram illustrating an example movement of pattern detection sensors in an image forming apparatus according to a second embodiment of the present disclosure. To perform the correction for the light beam scanning device 21-1, the pattern detection sensors 1a, 1c, and 1b are placed at the leading end, the trailing end, and the center of the light beam scanning device 21-1, respectively.

To perform the correction for the light beam scanning device 21-2, the pattern detection sensors 1a to 1c are moved toward the light beam scanning device 21-2 by a sensor movement actuator (e.g., the sensor movement actuator 3 illustrated in FIG. 4) such that the pattern detection sensors 1a, 1c, and 1b are placed at the leading end, the trailing end, and the center of the light beam scanning device 21-2, respectively. The pattern detection sensors 1a to 1c are simultaneously movable by the single sensor movement actuator 3.

The positions of the pattern detection sensors 1a and 1c are detected by sensor position detection sensors 2a and 2b disposed at both ends of the intermediate transfer belt 10. If the position of the pattern detection sensor 1a can be detected by the sensor position detection sensor 2a, it can be determined that the pattern detection sensors 1a to 1c are placed in position with respect to the light beam scanning device 21-1. If the position of the pattern detection sensor 1c can be detected by the sensor position detection sensor 2b, it can be determined that the pattern detection sensors 1a to 1c are placed in position with respect to the light beam scanning device 21-2.

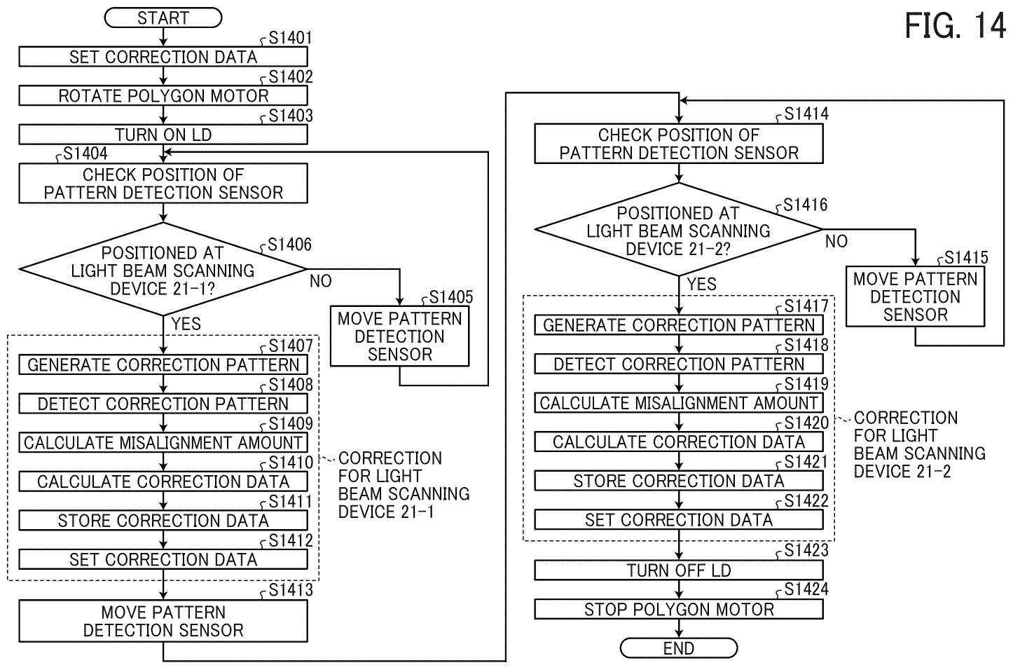

FIG. 14 is a flowchart illustrating an example of a pattern detection process during the movement of the pattern detection sensors 1a to 1c in the image forming apparatus according to the second embodiment of the present disclosure. The execution timings of the pattern detection process are similar to those described with reference to FIG. 11.

First, as a process for both the light beam scanning devices 21-1 and 21-2, the printer control unit 407 sets correction data stored in the storage unit 409 (step S1401). The correction data to be set here is correction data that is set in the previous correction operation and stored in the storage unit 409. Then, the printer control unit 407 rotates the polygon motor (step S1402) and turns on the LDs (step S1403).

Then, the printer control unit 407 checks the positions of the pattern detection sensors 1a to 1c using the sensor position detection sensors 2a and 2b (step S1404). If the pattern detection sensors 1a to 1c are not positioned at the light beam scanning device 21-1 (step S1406: No), the printer control unit 407 causes the sensor movement actuator 3 to move the pattern detection sensors 1a to 1c to the position of the light beam scanning device 21-1 (step S1405). As a process for the light beam scanning device 21-1, the printer control unit 407 generates correction patterns based on the light beam scanning device 21-1 (step S1407), detects the correction patterns using the pattern detection sensors 1a to 1c (step S1408), and calculates a misalignment amount (step S1409). Then, the printer control unit 407 calculates correction data (step S1410), causes the memory control unit 807 to store the correction data (step S1411), and sets the correction data (step S1412).

Then, the printer control unit 407 causes the sensor movement actuator 3 to move the pattern detection sensors 1a to 1c to the position of the light beam scanning device 21-2 (step S1413). The printer control unit 407 checks the positions of the pattern detection sensors 1a to 1c using the sensor position detection sensors 2a and 2b (step S1414). If the pattern detection sensors 1a to 1c are not positioned at the light beam scanning device 21-2 (step S1416: No), the printer control unit 407 causes the sensor movement actuator 3 to move the pattern detection sensors 1a to 1c to the position of the light beam scanning device 21-2 (step S1415).

As a process for the light beam scanning device 21-2, the printer control unit 407 generates correction patterns based on the light beam scanning device 21-2 (step S1417), detects the correction patterns using the pattern detection sensors 1a to 1c (step S1418), and calculates a misalignment amount (step S1419). Then, the printer control unit 407 calculates correction data (step S1420), causes the memory control unit 807 to store the correction data (step S1421), and sets the correction data (step S1422). Then, the printer control unit 407 turns off the LDs of both the light beam scanning devices 21-1 and 21-2 (step S1423) and stops the polygon motors (step S1424). Then, the process ends.

The image forming apparatus may perform the control described above during printing. In this case, the image forming apparatus performs the processing from the checking of the positions of the pattern detection sensors 1a to 1c to the setting of correction data for the light beam scanning device 21-2 between the printing of one image and the next image. In the present embodiment, in the image forming apparatus, correction data is set for the light beam scanning device 21-1 and the light beam scanning device 21-2 in this order. However, correction data may be set for the light beam scanning device 21-2 and the light beam scanning device 21-1 in this order as long as correction data is set at different times.

As described above, in the image forming apparatus according to the second embodiment, the pattern detection sensors 1a to 1c for the light beam scanning device 21-1 are used to detect correction patterns for both the two light beam scanning devices 21-1 and 21-2, resulting in a reduction in the number of components.

In the embodiments described above, an image forming apparatus according to an embodiment of the present disclosure is applied to a multifunction peripheral having at least two of a copying function, a printing function, a scanning function, and a facsimile function, by way of example, but not limitation. Another embodiment may provide any image forming apparatus such as a copying machine, a printer, a scanner, or a facsimile machine.

Aspects of the present disclosure are, for example, as follows.

In a first aspect, an image forming apparatus includes an optical writing device, an image forming device, and a correction device. The optical writing device includes multiple optical writing units arranged side by side in a scanning direction to each irradiate a respective one of divided regions of a scanning region on each of multiple first image bearers with a light beam to form a latent image, the divided regions being obtained by dividing the scanning region in the scanning direction.

The image forming device develops latent images, each formed by the optical writing device, with toners of different colors to form images of the different colors on the multiple first image bearers, and transfers the images of the different colors onto a second image bearer in a superimposed manner to form an image on the second image bearer.

The correction device forms correction patterns of each of the different colors on the second image bearer and corrects, based on detection of the correction patterns using multiple sensors, a positional misalignment for each of the multiple optical writing units.

A boundary portion between adjacent divided regions among the divided regions defines a region irradiated with light beams by two adjacent optical writing units among the multiple optical writing units.

The region is defined such that the divided regions irradiated with light beams by the two adjacent optical writing units overlap by a distance at one end of each of the divided regions.

The correction patterns include correction patterns generated in the region, each based on a corresponding one of the two adjacent optical writing units, and the correction patterns generated in the region are detected by a sensor common to the two adjacent optical writing units among the multiple sensors.

According to a second aspect, in the image forming apparatus of the first aspect, the correction patterns generated in the region are generated at different times for the two adjacent optical writing units and are detected by the sensor common to the two adjacent optical writing units at different times for the two adjacent optical writing units.

According to a third aspect, in the image forming apparatus of the first aspect or the second aspect, the region has a width in the scanning direction that is larger than a width of each of the correction patterns in the scanning direction.

According to a fourth aspect, in the image forming apparatus of any one of the first to third aspects, the multiple sensors used to detect the correction patterns are movable, and a detection position of each of the multiple sensors is switchable depending on an optical writing unit for which a correction pattern to be detected by the sensor is defined among the multiple optical writing units.

According to a fifth aspect, an image forming apparatus includes a first image bearer (40a) on which a first latent image and a second latent image are formed; a second image bearer (10) on which the first latent image and the second latent image are transferred from the first image bearer; an optical writing device (21) including: a first optical writer (21-1) to emit and scan a first light beam in a scanning direction onto a first scanning region in the first image bearer to form the first latent image on the first scanning region; and a second optical writer (21-2) adjacent to the first optical writer (21-1) in the scanning direction, the second optical writer to emit and scan a second light beam in the scanning direction onto a second scanning region in the first image bearer to form the second latent image on the second scanning region, and each end of the first scanning region and the second scanning region is overlapped in a first overlapping region of the first image bearer at a center of the first image bearer in the scanning direction; an image former (20a); and multiple sensors (1a, 1b, 1c, 1d, 1e). The image former develops the first latent image and the second latent image with a single-color toner into a first toner image and a second toner image, respectively; and transfers the first toner image and the second toner image onto the second image bearer (10) to respectively form: a first correction pattern in a first transfer region in the second image bearer corresponding to the first scanning region of the first image bearer; and a second correction pattern in a second transfer region in the second image bearer corresponding to the second scanning region of the first image bearer. Each end of the first transfer region and the second transfer region is overlapped in a second overlapping region of the second image bearer at a center of the second image bearer in the scanning direction. The multiple sensors (1a, 1b, 1c, 1d, 1e) detect at least one of the first correction pattern on the first transfer region or the second correction pattern on the second transfer region. The multiple sensors include a common sensor to detect both the first correction pattern and the second correction pattern in the second overlapping region on the second image bearer.

According to a sixth aspect, the image forming apparatus of the fifth aspect further includes circuitry configured to calculate a misalignment amount for each of the first optical writer and the second optical writer based on detection results of the multiple sensors; and generate correction data based on the misalignment amount calculated to correct a positional misalignment for each of the first optical writer and the second optical writer.

According to a seventh aspect, the image forming apparatus of the sixth aspect, further includes multiple first image bearers including the first image bearer (40a) on which the first latent image and the second latent image of different colors are formed; the second image bearer on which the first latent image and the second latent image of the different colors are transferred from the multiple first image bearers; multiple optical writing devices including the optical writing device (21), the multiple optical writing devices including: multiple first optical writers (21-1), including first optical writer, to form multiple first latent images, including the first latent image, of the different colors on the multiple first image bearers, respectively; and multiple second optical writers (21-2), including second optical writer, to form multiple second latent images, including the second latent image, of the different colors on the multiple first image bearers, respectively; and multiple image formers, including the image former (20a), to respectively form, on the second image bearer (10): multiple first correction patterns corresponding to the multiple first latent images of the different colors; and multiple second correction patterns corresponding to the multiple second latent images of the different colors; and multiple sets of multiple sensors including the multiple sensors, to detect at least one of the multiple first correction patterns or the multiple second correction patterns on the second image bearer (10).

According to an eighth aspect, in the image forming apparatus of the fifth aspect, the circuity is further configured to: cause the first optical writer (21-1) to form the first correction pattern at a first timing; and cause the second optical writer (21-2) to form the second correction pattern at a second timing different from the first timing. The multiple sensors detect the first correction pattern at a timing different from a timing of detecting the second correction pattern.

According to a ninth aspect, in the image forming apparatus of the fifth aspect, the image former (20a) forms the first correction pattern and the second correction pattern in the second overlapping region of the second image bearer in the scanning direction. Each of the first correction pattern and the second correction pattern has a first width smaller than a second width of the second overlapping region in the scanning direction.

According to a tenth aspect, the image forming apparatus of the sixth aspect, further includes a sensor actuator to move the multiple sensors in the scanning direction to detect the first correction pattern and the second correction pattern. The circuitry is further configured to cause the sensor actuator to move the multiple sensors to a first position to detect the first correction pattern to correct the positional misalignment of the first optical writer; or a second position to detect the second correction pattern to correct the positional misalignment of the second optical writer.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
a first image bearer on which a first latent image and a second latent image are formed;
a second image bearer on which the first latent image and the second latent image are transferred from the first image bearer;
an optical writing device including:
a first optical writer to emit and scan a first light beam in a scanning direction onto a first scanning region in the first image bearer to form the first latent image on the first scanning region; and
a second optical writer adjacent to the first optical writer in the scanning direction, the second optical writer to emit and scan a second light beam in the scanning direction onto a second scanning region in the first image bearer to form the second latent image on the second scanning region, and
each end of the first scanning region and the second scanning region is overlapped in a first overlapping region of the first image bearer at a center of the first image bearer in the scanning direction;
an image former to:
develop the first latent image and the second latent image with a single-color toner into a first toner image and a second toner image, respectively; and
transfer the first toner image and the second toner image onto the second image bearer to respectively form:
a first correction pattern in a first transfer region in the second image bearer corresponding to the first scanning region of the first image bearer; and
a second correction pattern in a second transfer region in the second image bearer corresponding to the second scanning region of the first image bearer, and
each end of the first transfer region and the second transfer region is overlapped in a second overlapping region of the second image bearer at a center of the second image bearer in the scanning direction; and
multiple sensors to detect at least one of the first correction pattern on the first transfer region or the second correction pattern on the second transfer region,
wherein the multiple sensors include a common sensor to detect both the first correction pattern and the second correction pattern in the second overlapping region on the second image bearer.

2. The image forming apparatus according to claim 1, further comprising:
circuitry configured to:
calculate a misalignment amount for each of the first optical writer and the second optical writer based on detection results of the multiple sensors; and
generate correction data based on the misalignment amount calculated to correct a positional misalignment for each of the first optical writer and the second optical writer.

3. The image forming apparatus according to claim 2, further comprising:
multiple first image bearers including the first image bearer on which the first latent image and the second latent image of different colors are formed;
the second image bearer on which the first latent image and the second latent image of the different colors are transferred from the multiple first image bearers;
multiple optical writing devices including the optical writing device, the multiple optical writing devices including:
multiple first optical writers, including first optical writer, to form multiple first latent images, including the first latent image, of the different colors on the multiple first image bearers, respectively; and
multiple second optical writers, including second optical writer, to form multiple second latent images, including the second latent image, of the different colors on the multiple first image bearers, respectively; and
multiple image formers, including the image former, to respectively form, on the second image bearer:
multiple first correction patterns corresponding to the multiple first latent images of the different colors; and
multiple second correction patterns corresponding to the multiple second latent images of the different colors; and
multiple sets of multiple sensors including the multiple sensors, to detect at least one of the multiple first correction patterns or the multiple second correction patterns on the second image bearer.

4. The image forming apparatus according to claim 1, wherein
the circuitry is further configured to:
cause the first optical writer to form the first correction pattern at a first timing; and
cause the second optical writer to form the second correction pattern at a second timing different from the first timing, and
the multiple sensors detect the first correction pattern at a timing different from a timing of detecting the second correction pattern.

5. The image forming apparatus according to claim 1, wherein
the image former forms the first correction pattern and the second correction pattern in the second overlapping region of the second image bearer in the scanning direction, and
each of the first correction pattern and the second correction pattern has a first width smaller than a second width of the second overlapping region in the scanning direction.

6. The image forming apparatus according to claim 2, further comprising a sensor actuator to move the multiple sensors in the scanning direction to detect the first correction pattern and the second correction pattern, and
the circuitry is further configured to cause the sensor actuator to move the multiple sensors to:
a first position to detect the first correction pattern to correct the positional misalignment of the first optical writer; or
a second position to detect the second correction pattern to correct the positional misalignment of the second optical writer.
